(19) United States
(12) Patent Application Publication
(10) Pub. No.: US 2012/0272921 A1
(43) Pub. Date: Nov. 1, 2012

(54) Kinetic rocking toy

(76) Inventor: Paul Santarsiero, Avon, CT (US)

(21) Appl. No.: 13/506,555

(22) Filed: Apr. 27, 2012

Related U.S. Application Data
(60) Provisional application No. 61/479,687, filed on Apr. 27, 2011.

(51) Int. Cl. A01K 29/00; A01K 15/02

(52) U.S. Cl. 119/707

(57) ABSTRACT

A Kinetic, reconfigurable modular structure having hollow track sub-components and an internal motioning device(s). The invention employs multiples of 1-5 unique modular hollow track part(s), each connecting to one another. A more basic version would use one repeatable, multi-positional modular track part. Both versions employ at least one internal motioning device(s). These modules connect securely to one another to create a multitude of 3-dimensional, rollercoaster-like tubular structures. The outer structure along with the internal motioning device(s) will easily rock or roll to and fro. The track modules assemble to create end-to-end structures or continuous loop structures where the internal device navigates throughout the structure. A continuous slot can be incorporated into the track modules to allow for unobstructed contact with the internal device. The internal device(s) can be battery powered thus allowing for self-propelled motion, vibration, sound, and/or lights. The integration of a motion sensor would automatically trigger these electronics.

### CROSS-REFERENC TO RELATED APPLICATION

This application claims the benefit of the U.S. Provisional Patent Application No. 61/479,687, entitled KINETIC ROCKING DEVICE and filed, in the name of the inventor hereof, on Apr. 27, 2011.

### BACKGROUND OF THE INVENTION

It is well known that Cats enjoy to be stimulated by motioning objects and toys and there are many options for the consumer to buy to entertain their small pet(s). The following United States patent documents represent prior art that could be considered germane to the present invention:
U.S. Pat. No. 7,806,087
U.S. Patent No. 20100058994A1
U.S. Patent No. 20100258060A1
U.S. Patent No. 20090308328A1
U.S. Patent No. 20080011244A1
U.S. Patent No. 20080141947A1
U.S. Patent No. 20080083378A1
U.S. Pat. No. 7,854,688
U.S. Pat. No. 5,870,971
U.S. Pat. No. 5,924,908
U.S. Pat. No. 5,809,938
U.S. Pat. No. 5,529,017
U.S. Pat. No. 5,544,623
U.S. Pat. No. 5,572,955
U.S. Pat. No. 5,351,650
U.S. Pat. No. 4,953,502
U.S. Pat. No. 4,722,299
U.S. Pat. No. 3,648,403

A variety of cat and infant toys which contain rolling balls and devices have been developed and marketed. However, until now, a device does not exist which engages your pet or infant in such a way as to provide a kinetic rocking structure by which the contained ball or other device rolls inside said structure and in such configurations that offers a variety of modular interpretations to the assembled. Each assembled design allows for interactive kinetic play both with the contained ball and/or device and the kinetic structure itself. The current products seen on the market assembly to make entertainment toys which lay flat on the ground plane. None of them allow the Parent or Pet Owner the ability to create 3D Rocking Structures and none of the existing products available today rock and motion when assembled. Existing products require the pet or child to move the trapped object within a defined flat laying track-like layout, and do not allow for gravity to move the whole assembled object structure and do not allow for gravity to interact with the internal balls they contain other than through simple friction on the ground plane laying components. This Kinetic Rocking Device invites the end user to engage with the whole structure of the product, whereas the existing devices on the market limit the focus of the user's attention to a motioning element inside a ground plane situated flat structure.

### SUMMARY OF THE INVENTION

Parent of infants and Pet Owners have ongoing needs to encourage, engage and entertain their infant child or pet. It is well known that pets which are bored can exhibit destructive behavior such as chewing on furniture, urinating indoors and in inappropriate places, excessive noise making, etc. which the pet naturally uses to communicate and to vent their frustration. It is also well known that bored and under-engaged Infants suffer from slower cognitive development due to lack of human and environmental stimulus.

The present invention relates to a Kinetic reconfigurable modular structure having interconnected hollow track sub-components and motioning ball or device(s) within. This assembled device raises up off the ground plane and has several modular embodiments wherein each of these embodiments allows the assembled structure to rock and motion. If enough inertia is extended on it a full roll may result when the structure is placed on a flat surface such as the floor. This Kinetic Rocking Device allows for full 360-degree axial connection options for the end-user, which is the reason the modules assemble into a varety of end structures.

### BRIEF DESCRIPTION OF THE ILLUSTRATED EMBODIMENTS

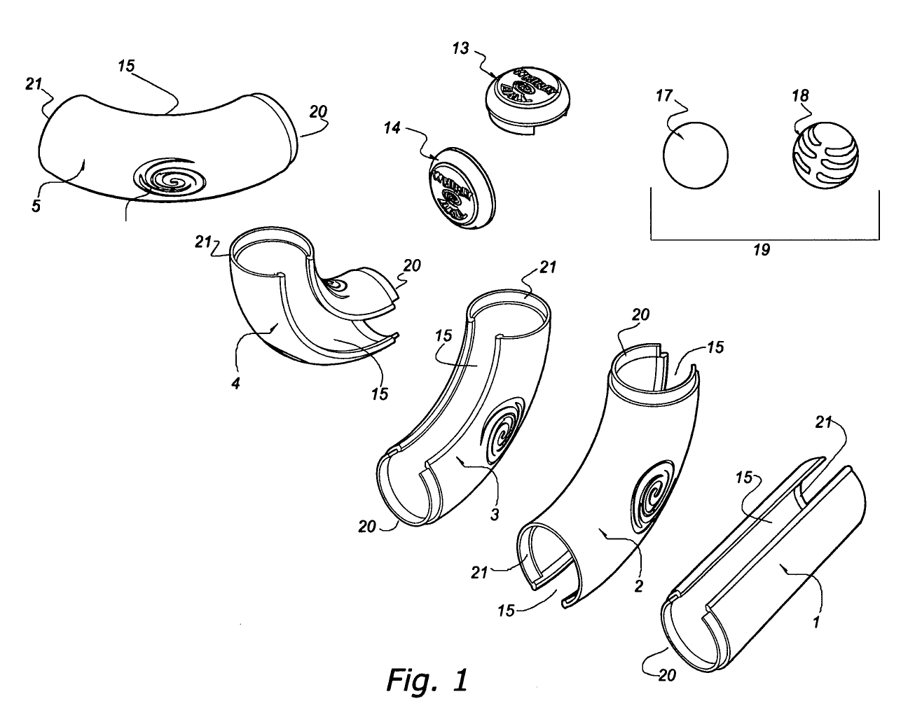

FIG. 1 is a perspective view of the modular components having a full slotted opening which allows uninterrupted access to the ball or device inside. These modules have a friction fit And snap assembly where the outer ends intersect into one another.

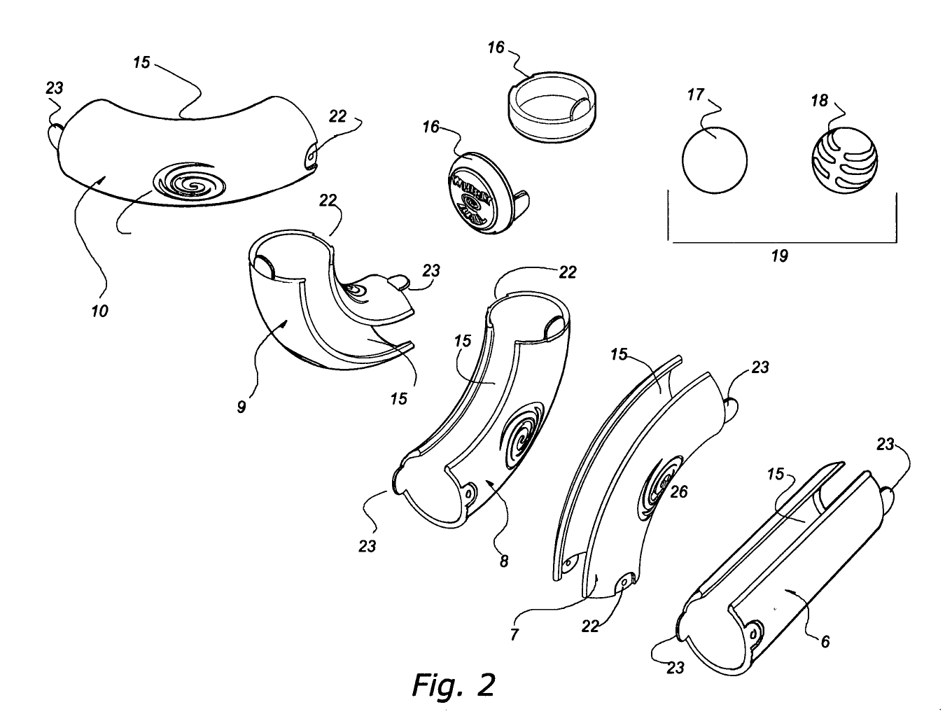

FIG. 2 is a perspective view of the of the modular components showing 2 modules which snap together having twin raised taps and negative receiving voids for these on the opposite side to allow part to be assembled in a series.

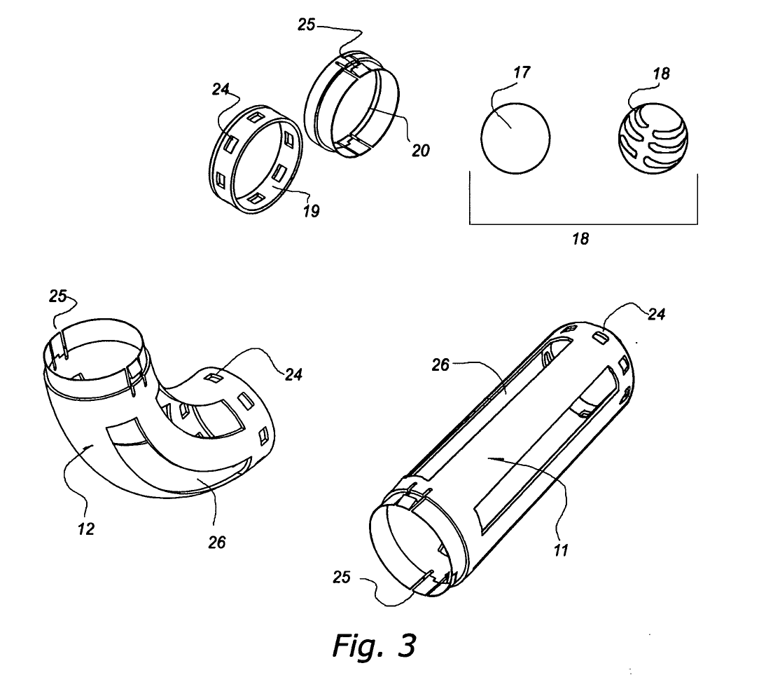

FIG. 3 is a perspective view of the of the modular components having a segmented slotted openings which does not allow for full access to the ball or device inside

These modules snap together having twin extending taps on one side of the part and which has 4 pairs of receiving slots on the opposite side of the part to accept the extension tabs from the next modular part.

FIG. 1 is a perspective view illustrating 8 unique subcomponents of a semicircular module engagement design.

FIG. 3 is a perspective view of 8 unique subcomponents of a tab intersection module engagement design.

FIG. 3 is a perspective view of 6 unique subcomponents of a radial tab intersection module engagement design.

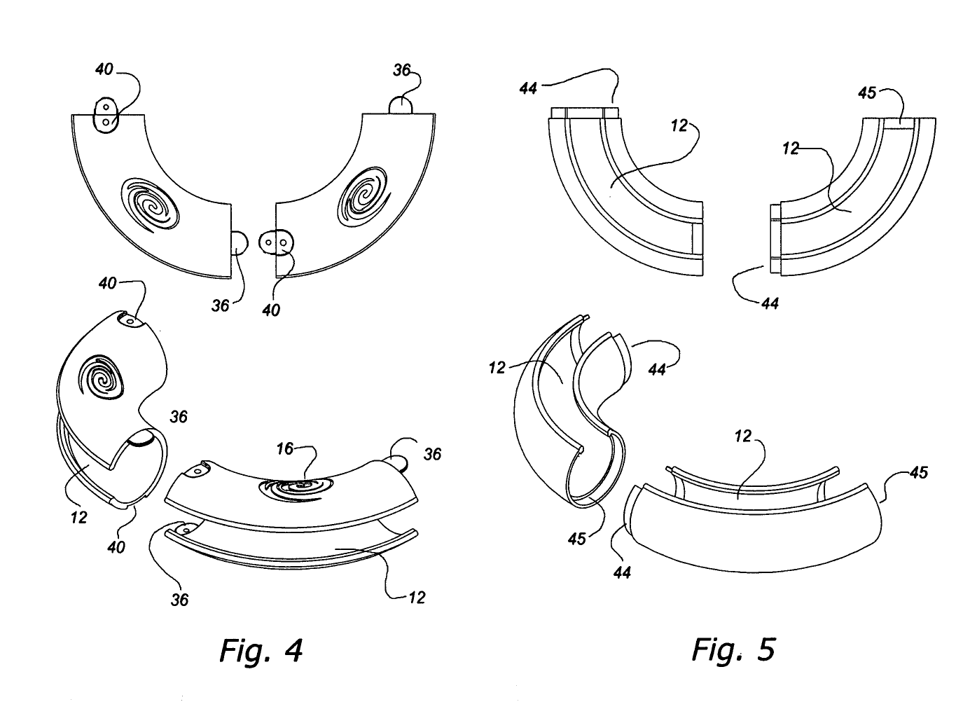

FIG. 4 is a perspective view of the 2 like 90 degree elbow modules shown in FIG. 2.

FIG. 5 is a perspective view of the 2 like 90 degree elbow modules shown in FIG. 1.

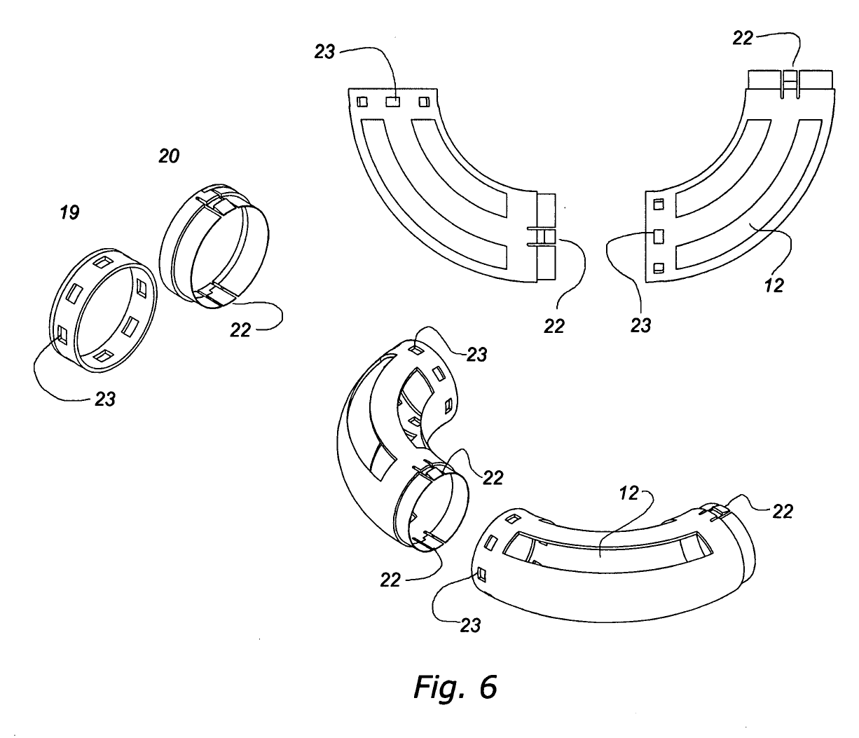

FIG. 6 is a perspective view of the end caps used on the modules which have 4 pairs of radial connection means and includes a perspective view of the of the end caps used with these modules parts.

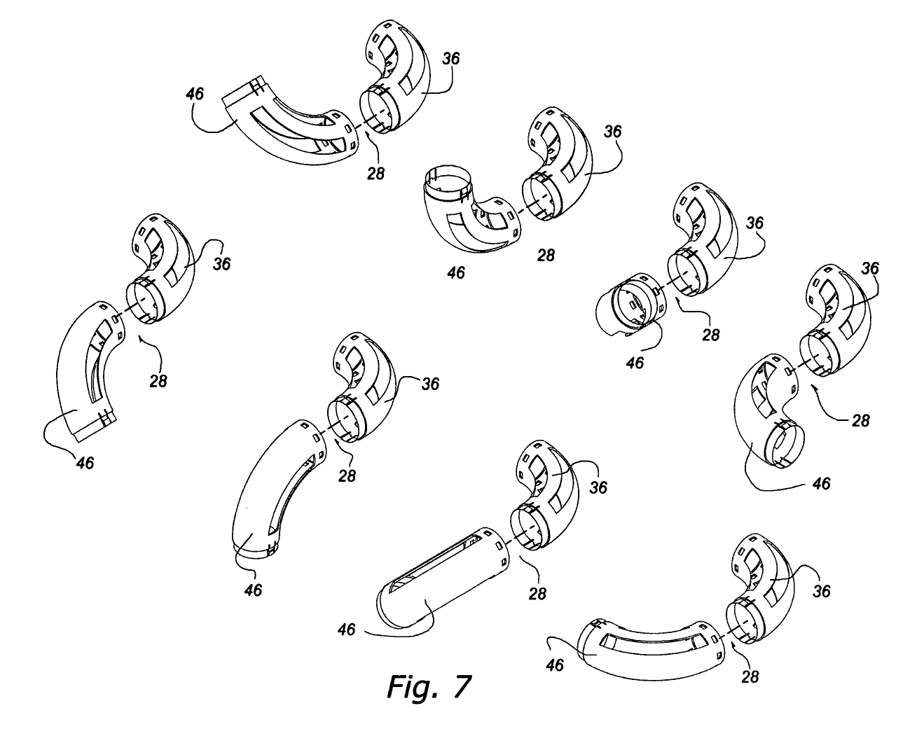

FIG. 7 is a perspective view which describes the 8 axial mating options for any 2 modules as seen in FIG. 3 illustration of the segmented slotted modules. Each of the mating relationships are 45 degrees rotated from one another.

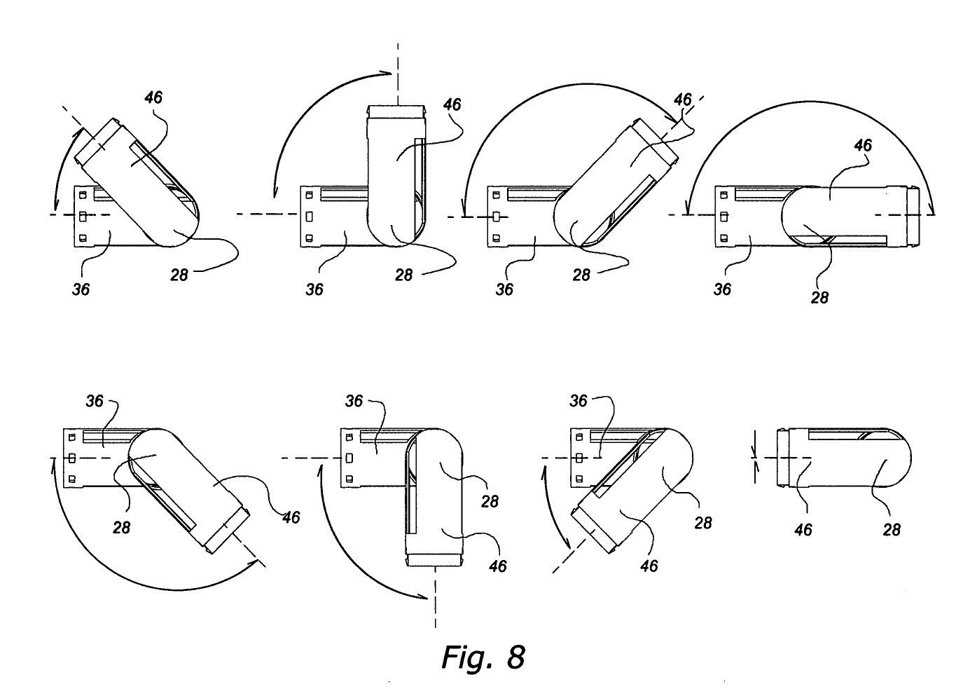

FIG. 8 is a front orthographic view which describes the 8 axial mating options for any 2 modules as seen in FIG. 3 illustration of the segmented slotted modules. Each of the mating relationships are 45 degrees rotated from one another.

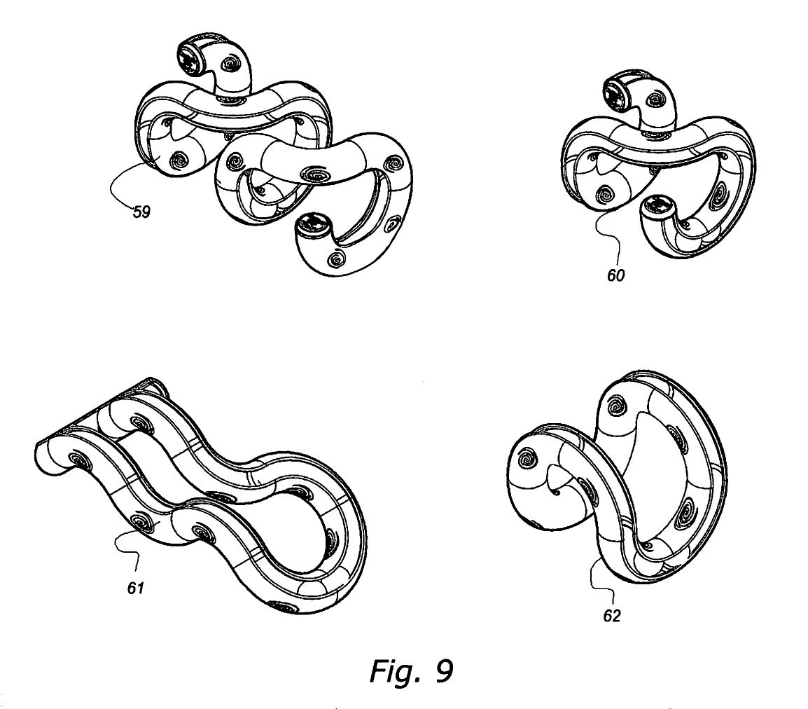

FIG. 9 is a perspective view showing 4 modular assembled Kinetic Rocking Structures based on FIG. 5 part design.

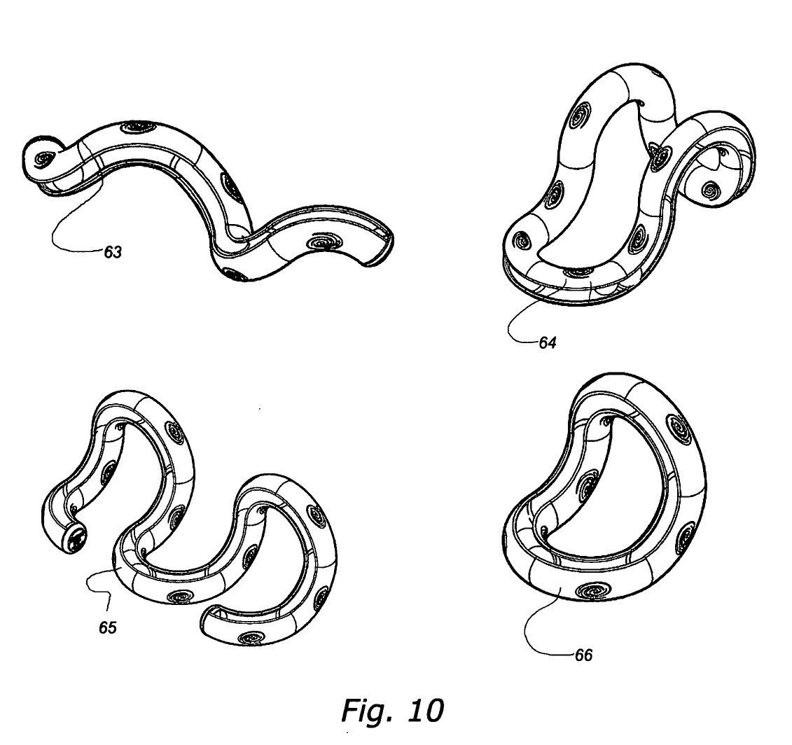

FIG. 10 is a perspective view showing an additional 4 modular assembled Kinetic Rocking Structures based on FIG. 5 part design.

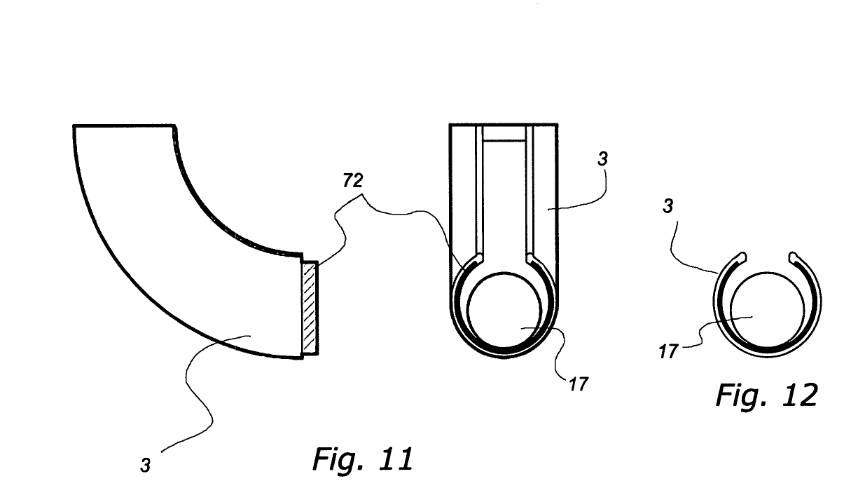

FIG. 11 shows orthographic vies of part 3 and the semi-circular extension tab that intersects with the opposite end of parts 1,2,4,5, and 6.

FIG. 12 shows a sectional view of part 3 showing the semi-circular part interface and the Rolling device 17 inside.

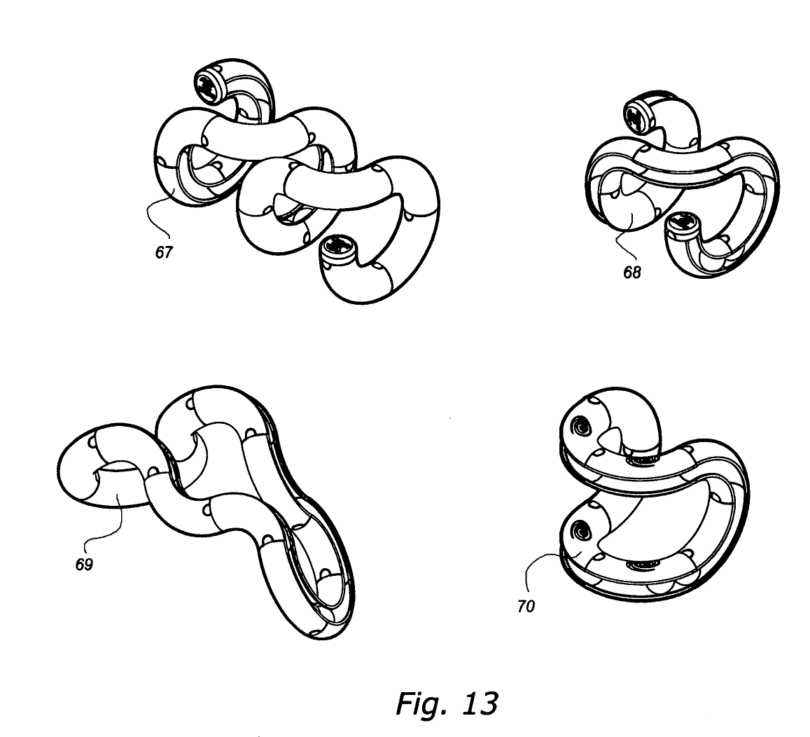

FIG. 13 is a perspective view showing 4 modular assembled Kinetic Rocking Structures based on FIG. 4 part design.

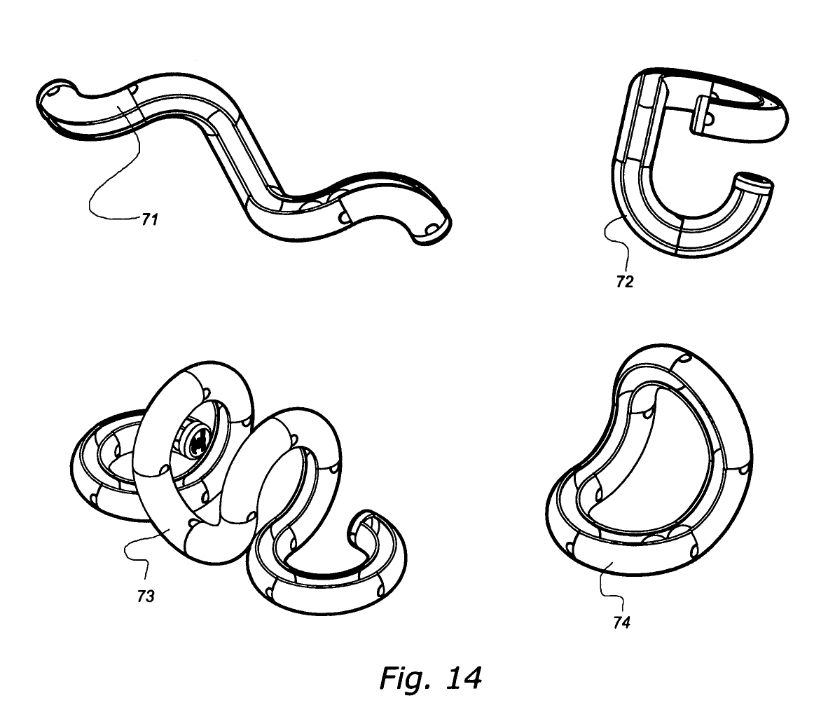

FIG. 14 is a perspective view showing an additional 4 modular assembled Kinetic Rocking Structures based on FIG. 4 part design.

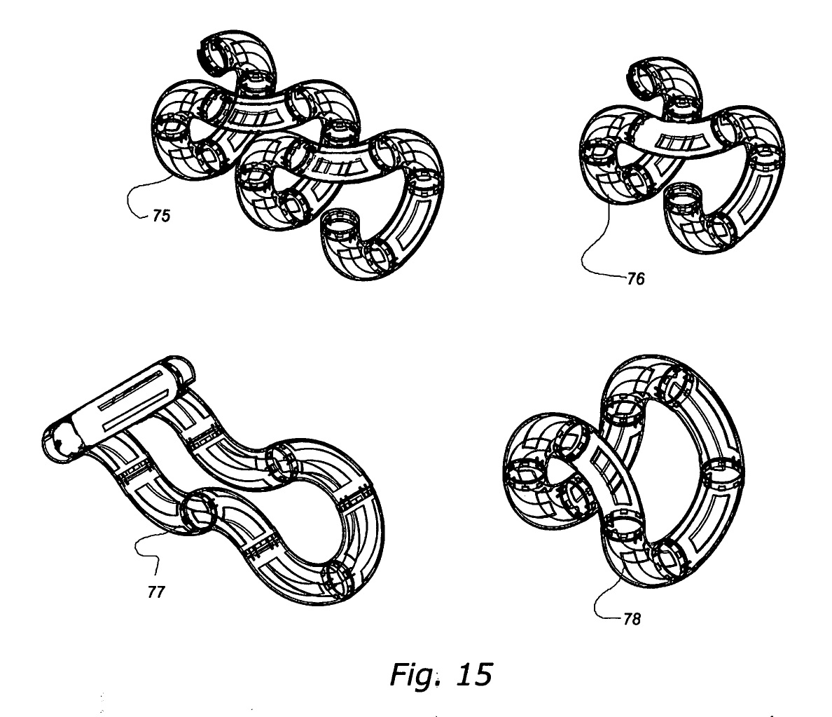

FIG. 15 is a perspective view showing 4 modular assembled Kinetic Rocking Structures based on FIG. 6 part design.

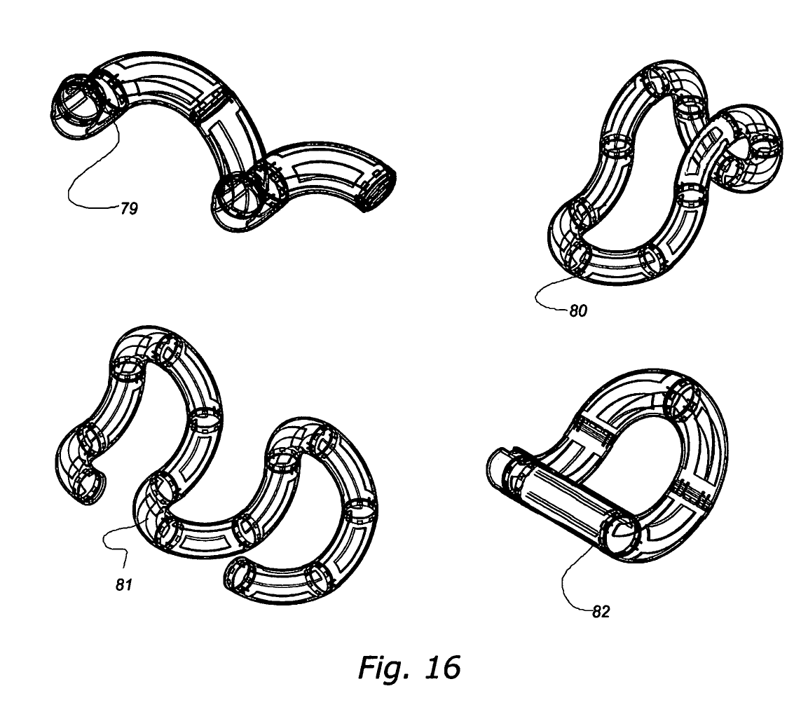

FIG. 16 is a perspective view showing an additional 4 modular assembled Kinetic Rocking Structures based on FIG. 6 part design.

The device is comprised of the following elements:
Seven or more different components make up the deluxe version of the invention and are listed below and as seen FIG. 1 illustrated parts 1, 2, 3,4, 5, 13, 17, and 18. These parts are preferably made out of injection molded plastic which would be durable, non-breakable and strong and also allow for the components to connect together without the need for secondary fasteners. The size of the assembled product will vary based on the style and type of structure that is assembled as shown in the FIG. 9 and FIG. 10 examples. The size of each Part; Straight Module 1, Elbow Module 2, Elbow Module 3, Elbow Module 4, and Elbow Module 5 sub-components range in size from 2″×2″ with a ½″ diameter up to 7″×7″×2″ in diameter with a preferred size of 4.5″×4.5″×1.5″ in diameter with a 1.25″ diameter ball 17 or device 18 inside. Device 18 is a deluxe spherical insert ball, whose embodiment can have a trapped bell, electronic or sound making device, or light emitting electronics inside. Parts for FIG. 1 are as follows:
Straight Tubular Part 1: with one or though hole more window slots.
Elbow Tubular Part 2: allows for a 90 degree connection with left facing through hole window slot.
Elbow Tubular Part 3: allows for a 90 degree connection with Top facing through hole window slot.
Elbow Tubular Part 4: allows for a 90 degree connection with Bottom facing through hole window slot.
Elbow Tubular Part 5: allows for a 90 degree connection with Right facing through hole window slot.
END CAP 13: Used in non-connected linear Modular Structures and inserts in module side 12.
END CAP 14: Used in non-connected linear Modular Structures and inserts in module side 11.
ROLLING DEVICE 17 and 18: 1 or more low friction rolling or motioning device such as a BALL with or without; electronics, motorized self-propulsion means, mechanical noise maker, or treat/scent pocket built in it that becomes trapped internally in the structure formed by the above parts.
ALL OF THE ABOVE Tubular PARTS assemble in various amounts and configurations create a completed structure with continuous through-hole windows located in each of these Modular Tubular parts. These windows allow for viewing and contact with the internal motioning device which may be a ping pong size ball or any weighted low friction motioning device.
The Tubular Elbow and Straight parts shown can be made to have cross-sectional shapes other than the round tubular shapes shown and can have a cross-sectional shapes of square, triangular, hexagonal or any polygon shape, or combination of polygon shape and arcs. When assembled the parts become a 3 dimensional linear progression of this polygon shape that makes for the containment for the moving device within.

### DETAILED DESCRIPTION OF THE ILLUSTRATED EMBODIMENTS

The Modules 11 and 12 shown in FIG. 3 are necessary for a bare minimum lowest cost product assembly. All parts shown FIG. 1, parts 1,2,3,4,5,13,17, and 18 embody an optimal means for interaction between the Child or pet by allowing for a continuous open slotted window 15 access for the child or pet to interact with the trapped Motioning Device within the structure.

The invention works through the use of modular Tubular connection parts. These parts are to be molded in a minimum of 2 unique connector parts 11 and 12 as seen in FIG. 3 or can have 7 parts or more parts as seen FIGS. 1,2,3,4,5,13,17, and 18 and FIG. 2 parts 6,7,8,9,10,16,17 and 18 which allow for maximum build options. The modular parts assemble together in a variety of ways and create a dozen or more rocking kinetic structures. The Kinetic Rocking Devices uniqueness is it's ability to be reconfigured by the parent, pet owner, in 3-dimensional space. A small ping-pong size ball 17 or other motioning device 18 is trapped inside the assembled structure which allowed to motion fully through the structure's twists and turns. Product Configurations 59, 60,61 and 62 shown in FIGS. 9 and 63, 64, 65, and 66, of FIG. 10 and FIG. 11 show a full un-interrupted continuous slotted Window elbow part 3 where the connection point tangency has a semi-circular profile engagement as seen in FIG. 11. The tab extension 72 on part 3 inserts into the opposite end of part 3 which has the inverse void to allow for a positive friction and friction and snap assembly of the parts. Product Modules on FIG. 6 make up the assembled modules of FIG. 15 and show an interrupted Slotted Window Structure 26 where the connection point tangency has a full circular profile engagement. Parts for FIG. 15 modularity are described as follows:

Straight Part 11:
A subset part of the product assembly which allows for a Straight Connection between Elbow Parts 12 and other straight parts 11. Straight part 11 connects to a part 12 with the snap together interface 25 being any of 8 potential radial mounting angles 24 and in any progression of desired-part 11 or 12 as seen in FIG. 7 and FIG. 8

Elbow Tubular Part 12:
A subset part of the product assembly which allows for a 90 degree Elbow Connection between Straight Parts 11 and other Elbow Parts 12. Elbow parts 12 connects to the other parts with the snap together interface 25 being any of 8 potential radial mounting angles 24 and in any progression of desired part 11 or 12 as seen in FIG. 7 and FIG. 8.

END CAP Parts 13 and 14:
A subset part of the product assembly which allows for a finish end cover to the open ends of certain non-closed structures. End Cap Parts 13 and 14 connect to each of the other Parts 11 and 12 any of their end points.
In one embodiment there is a unique male and female end cap to allow the caps to interface with the opposite connection end of each module. Another embodiment would utilize identical universal fitting end caps 16 illustrated in FIG. 2 which would assemble to either end of parts 6,7,8,9, and 10.

MOTIONING DEVICE 17 and 18:
One or more low friction rolling or motioning device such as a BALL 17 and 18 with or without electronics, mechanical nose maker, or motioning device with a treat/scent pocket built-in that becomes trapped internally in the structure formed by the above parts. This device can have parts assembled to, it such as colorful feathers, streamers, or external light-up elements such as fiber optics, that protrude to the outside of the structure and act as an means of enhancing the visual movement for the product. This motioning device can also be self-powered and have an onboard motor which would allow it to move self-propelled inside the structure(s) without the need for gravity interaction. An alternate embodiment would be to have the magnetic interaction between the internal motioning device and an outside magnet. The trapped magnet (or metal part) of the motioning device would be attracted to an external motioning magnet located outside of the motioning device. This external magnet could be in the form of a completely separate part such as a wand that the end user manipulates or can be contained in the above modular structure parts. If embedded in the modular parts the magnets can have opposing polarity to the motioning device's magnet which would cause it to pushed as it passes by these magnets. Electronics could serve to create patterns of attracting and opposing polarity inside the structures to allow for electronic induced motion to affect the motioning device. Another embodiment would use an external force such as a motor with roller wheels mounted somewhere along the structure which would contact and interact with the motioning device by having roller wheels contact it to thrust it through the structure. Yet another embodiment would utilize an external device, or sound, or light, or heat, or vibration, or other sensory device to trigger electronics inside or outside of the motioning device.
Parts 1,2,3,4 and 5 and 6, 7, 8, 9, and 10 each allow for the Window or Slot facing 15 to remain continuous between assembled parts while the parts change lateral orientation to one another and also when like-parts are assembled to one another with no lateral change. The window slot's 15 location can vary on the outside of the assembled structure and can be on the top, sides, bottom, front or back. There are a total of 6 different facing orientations to this Window or slot and an example their difference is seen on the 6 different facing directions of a Cube shape.
FIG. 13 shows parts 6, 7, 8, 9 and 10 all assembled to form kinetic rocking structures 3 of which are closed loop structures.

The invention works through the use of modular Tubular (or any other profile polygon shaped hollowed-out profile form) connection parts. These parts are to be molded in a minimum of one unique connector parts as seen in FIG. 3 part 12 and can have up to 5 parts as seen in FIGS. 1 and FIG. 2 in order to achieve maximum build options as referenced in FIGS. 9 and FIGS. 10, and when assembled, all become rocking structures which have an internal rolling component(s). The interplay of the internal rolling component(s), whether a simple ping pong ball 17 like part or an enhanced rolling device with mechanical sound 18, electronic sound and/or lights, self-propulsion, or with a treat/scent pocket together with the outer rocking/teetering structure will entertain, delight, and invite interaction from infants and is equally entertaining to cats and possibly other pets.

Modular Parts 1, 2, 3, 4 and 5 as seen in FIG. 1 and Modular Parts 6, 7, 8, 9 and 10 as seen in FIG. 2 each can be assembled in a multitude of ways to create a dozen or more kinetic structures.

FIG. 3 features only one elbow 12 and one straight Module part 11 instead of utilizing the 4 elbows parts shown in FIG. 1 and FIG. 2. The 1, multi-position able Elbow 12 shown in FIG. 3 allows the user to make the connection of this elbow at 8 different lateral connection points when mating opposite to opposite end of a like elbow 12 or straight part 11, and allow a second assembled elbow part 12 to extend to one of 8 different directions, all being 45 degrees from one another. The Straight connector part 11, can also can connect in 8 different axial rotations points to the previous connector, each with a 45 Degree change of lateral angle as seen on the Elbow to Elbow connection means. Given the 360 degree lateral angle choices, the invention allows for 8 equal 45 degree axial rotation choices when connecting any combination of Part 12 and Part 11 shown in FIG. 3. A greater number of snap and receptor snap locations are considered as part of this invention, through having more axial location snap points added, thus allowing for a greater multitude of intersection and lateral twist combinations that are not shown here. This connection point could also be rotationally infinite such that the user can rotate any of the modules at their connection point to achieve any desired lateral angle within 360 degrees of rotation.

The elbow shapes shown on FIG. 1 parts 2,3,4,5, and FIG. 2 parts 6,7,8,9, and 10 attach. to each of their respective subset parts in only one direction angle twist and require the user to match the window thorough hole single slot of 2 elbows at their intersection point.

The invention is to be made in high volume injection molding machines and each individual Modules can be molded as a one piece part through complex side action in the Injection Molding or can be made in 2 sub-component parts which are assembled together through means of glue, screws, dart-head connections, or ultrasonic weld technologies. The End Caps 13,14,16,19 and 20 are also to be Injection Molded and will have the ability to connect to the Modular parts in the same means that each of the parts individually connect to one another. Consumer connection of parts can be made through friction caused by them sliding snug fitting parts into one another, male and female interconnectivity of parts which may and may not utilize secondary connector sleeve or tab parts, bayonet mounting means or detent over-snap interference connection means. They parts could also magnetically attach to one another or by means of Hook and Loop, suction cup fasteners, or glue.

The Modular parts can be assembled, disassembled, and reassembled by the consumer to form a multitude of structures. This device can be made new again by simply changing it's configuration and thus creating new levels of complexity for infants or pets to engage with.

Having thus described the invention, what is claimed is:

1. A kinetic reconfigurable modular Infant or Cat toy comprised of modular hollow track sub-components and trapped motioning ball or device(s) inside in which both are together coaxed to move by a simple push or pull by an infant or cat when delivered on the assembled structure.

2. An Infant or Cat toy comprised of modular track sub-component system of parts which allow for unique Curvilinear, helical, and spherical like structures to be built wherein each structure inherent unstable on the ground plane, and therefore will rock and roll when the slightest force is exerted on it.

3. A kinetic reconfigurable modular Infant or Cat toy which has a continuous slotted opening running unimpeded throughout the structure to allow a ball or device contained within it to be approachable by a child or pet throughout it's 3-dimensionally defined linear progression.

4. A kinetic reconfigurable modular Infant or Cat toy of claim 1 which has modular components that allow for a multitude of structures to be built from a subset grouping of modular parts, through snap and unsnap integral connectors which are molded into the track parts.

5. A kinetic reconfigurable modular Infant or Cat toy of claim 1 wherein it's simplest embodiment would include one repeatable design of a 90 degree elbow module having 8 or more radial connection options for it to mated to it's identical repeated part.

6. A kinetic reconfigurable modular Infant or Cat toy of claim 1 which is inherently unstable and will rock and motion to and fro with the slightest push or pull by a child or pet.

7. A kinetic reconfigurable modular toy of claims 2, which would have male and female intersecting semicircular protrusions and recesses at opposite ends of each modular part to allow for their snap together connections to one another.

8. A kinetic reconfigurable modular toy of claims 2 which would have a secondary friction interference of a detent and positive snap connection such that the assembled modules would stay together unless deliberately pulled apart by an adult.

9. A kinetic reconfigurable modular Infant or Cat toy of claim 2 which can have as many as 5 or more modular track parts, some of which have 90 degree directional changing properties will others can be straight inline modular parts.

10. kinetic reconfigurable modular Infant or Cat toy of claim 2 which utilizes End Caps to contain the motioning ball or device within.

11. A kinetic reconfigurable modular Infant or Cat toy of claim 2 which would include a battery operated or wind-up motor which would cause the structure and ball device to move independently along the ground plane.
